(19) United States
(12) Patent Application Publication
(10) Pub. No.: US 2026/0097977 A1
(43) Pub. Date: Apr. 9, 2026

(54) METHODS OF REDUCING MICROORGANISM GROWTH, INFECTIVITY, AND/OR SURVIVAL IN WATER VIA NANO-GALVANIC ALUMINUM POWDER

(71) Applicants: The Board of Trustees of The University of Alabama, Tuscaloosa, AL (US); U.S. Army Army Research Laboratory, Aberdeen Proving Ground, MD (US)

(72) Inventors: Aaron C. Blackwell, Tuscaloosa, AL (US); Mark Elliott, Tuscaloosa, AL (US); Gregory B. Thompson, Tuscaloosa, AL (US); Billy Chad Hornbuckle, Aberdeen Proving Ground, MD (US); Anit K. Giri, Aberdeen Proving Ground, MD (US); Kris A. Darling, Aberdeen Proving Ground, MD (US); Anthony J. Roberts, JR., Aberdeen Proving Ground, MD (US)

(21) Appl. No.: 19/293,526

(22) Filed: Aug. 7, 2025

Related U.S. Application Data
(60) Provisional application No. 63/705,264, filed on Oct. 9, 2024.

(51) Int. Cl. C02F 1/68; C02F 1/02

(52) U.S. Cl. CPC C02F 1/68; C02F 1/02; C02F 2305/08

(57) ABSTRACT

The present disclosure provides for a method of reducing microbial growth, infectivity, and/or survival, the method comprising contacting a microbe containing aqueous stream with a nano-galvanic aluminum material. Also provided herein is a wastewater treatment device comprising an enclosure, wherein the enclosure comprises a nano-galvanic aluminum material and a microbe containing aqueous stream, wherein the nano-galvanic aluminum material and the microbe containing aqueous stream are in contact with each other within the enclosure. Further provided herein is a water treatment system comprising a nano-galvanic aluminum material and a microbe containing aqueous stream.

### CROSS-REFERENCE TO RELATED APPLICATIONS

This application claims the benefit of priority to U.S. Provisional Application No. 63/705,264 filed Oct. 9, 2024, which is hereby incorporated herein by reference in its entirety.

### STATEMENT OF GOVERNMENT SUPPORT

This invention was made with government support under Award No. W911NF2120025, awarded by the US Army Research Lab. The government has certain rights in the invention.

### BACKGROUND

Access to clean water is required to fulfill basic human needs, such as hydration and cleanliness. Remote regions can have difficulty accessing clean water which can cause issues with keeping people and animals well hydrated, as well as maintaining cleanliness to safe standards, among other things. Access to clean water can also be impacted by infrastructure that has been disrupted, such as by conflict or natural disasters. In many situations, water is available, but it is not clean and contains microbes and pathogens making it unusable. There is a need for disinfecting existing water supplies such that the water can be reused for purposes such as drinking and cleanliness.

The methods and products disclosed herein address these and other needs.

### SUMMARY

In accordance with the purposes of the disclosed materials and methods, as embodied and broadly described herein, the disclosed subject matter, in one aspect, relates to nano-galvanic aluminum material.

Thus, in one example, a method of reducing microbial growth, infectivity, and/or survival is provided, including contacting a microbe-containing aqueous stream with a nano-galvanic aluminum material.

In some examples, the nano-galvanic aluminum material is a powder.

In some examples, the nano-galvanic aluminum material is a green compact, fully dense piece, or 3D printed lattice-type structure.

In some examples, the microbe containing aqueous stream is contacted with an amount of the nano-galvanic aluminum material sufficient to generate heat, thereby reducing microbial growth, infectivity, and/or survival.

In some examples, the nano-galvanic aluminum material comprises an anodic matrix. In some examples, the anodic matrix comprises aluminum, an aluminum alloy, or another aluminum-based composition.

In some examples, the nano-galvanic aluminum material comprises a cathodic phase comprising gallium, lead, manganese, silicon, magnesium, copper, bismuth, tin, or mixtures or alloys thereof.

In some examples, the cathodic phase is a disperse phase.

In some examples, the gallium, lead, manganese, silicon, magnesium, copper, bismuth, tin, or mixtures or alloys thereof are in a small particle.

In some examples, the cathodic phase comprises tin. In some examples, the cathodic phase comprises from more than 0 to 20% by weight of tin. In some examples, the cathodic phase comprises from 2 to 8% by weight of tin.

In some examples, the cathodic phase comprises bismuth. In some examples, the cathodic phase comprises from more than 0 to 20% by weight of bismuth. In some examples, the cathodic phase comprises from 3 to 8% by weight of bismuth.

In some examples, the cathodic phase comprises copper, silver, zinc, iron, or any combination thereof.

In some examples, the aluminum alloy in the anodic matrix comprises 1000 series aluminum, 2000 series aluminum, 3000 series aluminum, 4000 series aluminum, 5000 series aluminum, 6000 series aluminum, 7000 series aluminum, or any combination thereof.

In some examples, the microbe comprises a pathogen, wherein the pathogen is a virus, bacteria, fungi, protozoa, worm, or any combination thereof. In some examples, the pathogen is a bacteria. In some examples, the bacteria is coliform. In some examples, the coliform is Escherichia coli (E. coli).

In some examples, the microbe containing aqueous stream comprises wastewater. In some examples, the wastewater comprises domestic wastewater, industrial wastewater, commercial wastewater, agricultural wastewater, or any combination thereof.

In some examples, the small particle in the cathodic phase has an average characteristic dimension of 1 millimeter (mm) or less.

In some examples, the small particle in the cathodic phase has an average characteristic dimension of 1000 nanometers (nm) or less.

In some examples, the small particle in the cathodic phase has an average characteristic dimension of 500 nm or less.

In some examples, the small particle in the cathodic phase has an average characteristic dimension of 200 nm or less.

In some examples, the small particle in the cathodic phase has an average characteristic dimension of 100 nm or less.

In some examples, the small particle in the cathodic phase has an average characteristic dimension of 50 nm or less.

In a further example, a wastewater treatment device is provided, including an enclosure, wherein the enclosure comprises a nano-galvanic aluminum material and a microbe containing aqueous stream, wherein the nano-galvanic aluminum material and the microbe containing aqueous stream are in contact with each other within the enclosure.

Additionally, a water treatment system is provided, including a nano-galvanic aluminum material and a microbe-containing aqueous stream.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The accompanying figures, which are incorporated in and constitute a part of this specification, illustrate several aspects described below.

FIG. 1 shows a beginning stage of an example reaction as described herein.

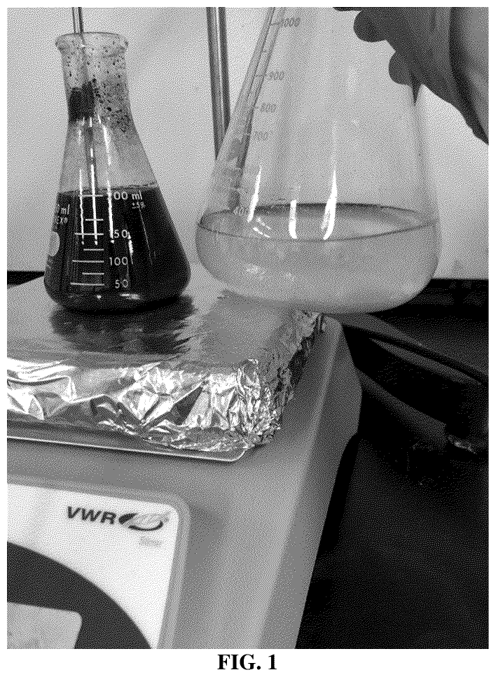

FIG. 2 shows a later stage of an example reaction as described herein.

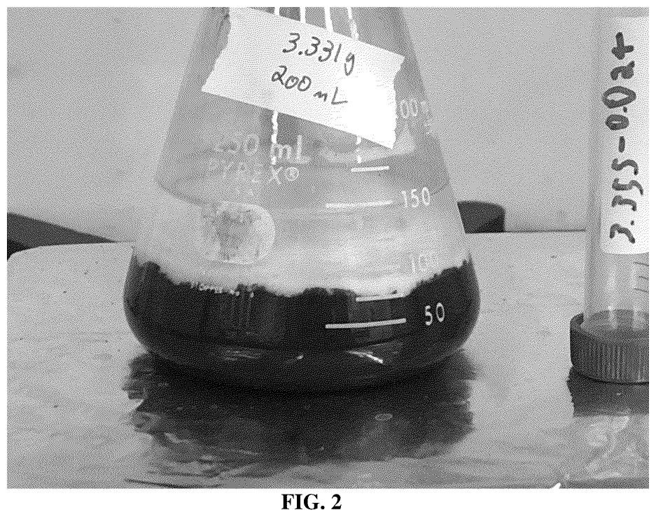

FIG. 3 shows the reduction in MS2 virus concentration total coliform inactivation in log-10 units (1-log corresponds to 90% reduction, 2-log corresponds to 99% reduction, 3-log corresponds to 99.9%, etc.) with time. More specifically, the nano-galvanic aluminum powders inactivated or removed the MS2 virus. These two experimental results were achieved on ice to control temperature. This reflects the non-heat mechanisms of microbial reduction.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a composition”, or “a disorder”, includes, but is not limited to, two or more such compounds, compositions, or disorders, and the like.

It should be noted that ratios, concentrations, amounts, and other numerical data can be expressed herein in a range format. It can be further understood that the endpoints of each of the ranges are significant both in relation to the other endpoint, and independently of the other endpoint.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘x, y, z, or less’ and should be interpreted to include the specific ranges of ‘x’, ‘y’, and ‘z’ as well as the ranges of ‘less than x’, less than y’, and ‘less than z’. Likewise, the phrase ‘x, y, z, or greater’ should be interpreted to include the specific ranges of ‘x’, ‘y’, and ‘z’ as well as the ranges of ‘greater than x’, greater than y’, and ‘greater than z’. In addition, the phrase “‘x’ to ‘y’”, where ‘x’ and ‘y’ are numerical values, includes “‘x’ to ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also include individual values (e.g., 1%, 2%, 3%, and 4%) and the sub-ranges (e.g., 0.5% to 1.1%; 5% to 2.4%; 0.5% to 3.2%, and 0.5% to 4.4%, and other possible sub-ranges) within the indicated range.

“Optional” or “optionally” means that the subsequently described event or circumstance can or cannot occur, and that the description includes instances where the event or circumstance occurs and instances where it does not.

For the terms “for example” and “such as,” and grammatical equivalences thereof, the phrase “and without limitation” is understood to follow unless explicitly stated otherwise. It is further understood that these phrases are not used in a restrictive sense, but for explanatory purposes. “Exemplary” means “an example of” and is not intended to convey an indication of a preferred or ideal embodiment.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “and/or” includes any and all combinations of one or more of the associated listed items.

As used herein, the term “substantially” means that the subsequently described event or circumstance completely occurs or that the subsequently described event or circumstance generally, typically, or approximately occurs.

Still further, the term “substantially” can, in some aspects, refer to at least about 80 %, at least about 85 %, at least about 90 %, at least about 91 %, at least about 92 %, at least about 93%, at least about 94 %, at least about 95 %, at least about 96 %, at least about 97 %, at least about 98 %, at least about 99 %, or about 100 % of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1 % by weight, e.g., less than about 0.5 % by weight, less than about 0.1 % by weight, less than about 0.05 % by weight, or less than about 0.01 % by weight of the stated material, based on the total weight of the composition.

A weight percent (wt. %) of a component, unless specifically stated to the contrary, is based on the total weight of the formulation or composition in which the component is included.

A volume percent (vol %) of a component, unless specifically stated to the contrary, is based on the total volume of the formulation or composition in which the component is included.

### Methods

### Method of Reducing Microbial Growth, Infectivity, and/or Survival

The present disclosure, in one aspect, provides for a method of reducing microbial growth, infectivity, and/or survival, the method comprising contacting a microbe-containing aqueous stream with a nano-galvanic aluminum material.

As used herein a “nano-galvanic aluminum material” can comprise a nanostructured galvanic aluminum material. As used herein, “nanostructured” means any structure with one or more nanosized features. A nanosized feature can be any feature with at least one dimension less than 1 micrometer (μm) in size. For example, a nanosized feature can comprise a nanowire, nanotube, nanoparticle, nanopore, and the like, or combinations thereof. As such, the nanostructured metal can comprise, for example, a nanowire, nanotube, nanoparticle, nanopore, or a combination thereof. In some examples, the nanostructured material can comprise a material that is not nanosized but has been modified with a nanowire, nanotube, nanoparticle, nanopore, or a combination thereof.

As used herein a “nano-galvanic aluminum material” can comprise a plurality of particles, wherein each particle comprises a plurality of grains. The plurality of particles can have an average particle size, wherein the average particle size is on the micrometer scale, such as from 40 to 100 microns (micrometers, μm). The plurality of grains can have an average gain size that is on the nanoscale. As used herein, the term “nanoscale” refers to an average characteristic dimension of grains less than 1000 nm, and in some examples, less than 100 nm or less than 10 nm. In some examples, the plurality of grains can have an average grain size of 100 nm or less. This combination allows for the nano-galvanic aluminum material to prevent being passivated when in contact with water and cause hydrolysis, but also not be pyrophoric when in air.

In some examples, the nano-galvanic material comprises a plurality of particles having an average particle size of 1 micron (micrometers, μm) or more (e.g., 5 microns or more, 10 microns or more, 15 microns or more, 20 microns or more, 25 microns or more, 30 microns or more, 35 microns or more, 40 microns or more, 45 microns or more, 50 microns or more, 55 microns or more, 60 microns or more, 65 microns or more, 70 microns or more, 75 microns or more, 80 microns or more, 85 microns or more, 90 microns or more, 95 microns or more, 100 microns or more, 110 microns or more, 120 microns or more, 130 microns or more, 140 microns or more, 150 microns or more, 175 microns or more, 200 microns or more, 225 microns or more). In some examples, the nano-galvanic material comprises a plurality of particles having an average particle size of 250 microns or less (e.g., 225 microns or less, 200 microns or less, 175 microns or less, 150 microns or less, 140 microns or less, 130 microns or less, 120 microns or less, 110 microns or less, 100 microns or less, 95 microns or less, 90 microns or less, 85 microns or less, 80 microns or less, 75 microns or less, 70 microns or less, 65 microns or less, 60 microns or less, 55 microns or less, 50 microns or less, 45 microns or less, 40 microns or less, 35 microns or less, 30 microns or less, 25 microns or less, 20 microns or less, 15 microns or less, 10 microns or less, or 5 microns or less). The average particle size can range from any of the minimum values described above to any of the maximum values described above. For example, the nano-galvanic material comprises a plurality of particles having an average particle size of from 10 to 250 microns (e.g., from 1 to 125 microns, from 125 to 250 microns, from 1 to 50 microns, from 50 to 100 microns, from 100 to 150 microns, from 150 to 200 microns, from 200 to 250 microns, from 1 to 200 microns, from 1 to 150 microns, from 1 to 100 microns, from 5 to 250 microns, from 10 to 250 microns, from 25 to 250 microns, from 50 to 250 microns, from 100 to 250 microns, from 5 to 200 microns, from 10 to 150 microns, or from 40 to 100 microns). In some examples, the nano-galvanic material comprises a plurality of particles having an average particle size of from 40 to 100 microns.

In some examples, the plurality of grains can have an average grain size of 1000 nanometers (nm) or less (e.g., 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 140 nm or less, 130 nm or less, 120 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, 10 nm or less, or 5 nm or less). In some examples, the plurality of grains can have an average grain size of 100 nm or less. In some examples, the plurality of grains can have an average grain size of 50 nm or less. In some examples, the plurality of grains can have an average grain size of 10 nm or less.

In some examples, the plurality of grains can have an average grain size of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, 95 nm or more, 100 nm or more, 110 nm or more, 120 nm or more, 130 nm or more, 140 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, or 900 nm or more).

The average grain size of the plurality of grains can range from any of the minimum values described above to any of the maximum values described above. For example, the plurality of grains can have an average grain size of from 1 to 1000 nm (e.g., from 1 to 500 nm, from 500 to 1000 nm, form 1 to 200 nm, from 200 to 400 nm, from 400 to 600 nm, from 600 to 800 nm, from 800 to 1000 nm, from 1 to 800 nm, from 1 to 600 nm, from 1 to 400 nm, from 1 to 100 nm, from 1 to 50 nm, or from 1 to 10 nm). In some examples, the plurality of grains can have an average grain size of from 1 to 100 nm. In some examples, the plurality of grains can have an average grain size of from 1 to 50 nm. In some examples, the plurality of grains can have an average grain size of from 1 to 10 nm. In some examples, the plurality of grains can have an average grain size of from 5 to 100 nm. In some examples, the plurality of grains can have an average grain size of from 5 to 50 nm. In some examples, the plurality of grains can have an average grain size of from 5 to 10 nm.

The nano-galvanic aluminum material described herein is useful for generating hydrogen gas when contacted with water or water-containing liquids including but not limited to black water, gray water, urine, pond water and so forth. Aluminum-based alloys can be made to generate hydrogen very rapidly by reaction with water at room temperature by forming galvanic cells.

In some examples, the nano-galvanic aluminum material provides spontaneous, facile and rapid generation of hydrogen at room or elevated temperatures without externally applied power, by reacting the composition with water and/or liquids containing water.

In some examples, the nano-galvanic aluminum material comprises aluminum. In further examples, the nano-galvanic aluminum material comprises an alloy of aluminum.

In certain examples, the alloy of aluminum comprises 50% by weight or more of aluminum (e.g., 55% or more, 60% or more, 65% or more, 70% or more, 75% or more, 80% or more, or 85% or more). In some examples, the alloy of aluminum comprises 90% by weight or less of aluminum (e.g., 85% or less, 80% or less, 75% or less, 70% or less, 65% or less, 60% or less, or 55% or less). The amount of aluminum in the alloy can range from any of the minimum values described above to any of the maximum values described above. For example, the alloy of aluminum can comprise from 50 to 90% by weight of aluminum (e.g., from 50 to 70%, from 70 to 90%, from 50 to 60%, from 60 to 70%, from 70 to 80%, from 80 to 90%, from 50 to 80%, from 60 to 90%, or from 60 to 80%).

In some examples, the nano-galvanic aluminum material is a powder.

In some examples, the nano-galvanic aluminum material is a green compact, fully dense piece, or 3D printed lattice-type structure.

In further examples, the microbe containing aqueous stream is contacted with an amount of the nano-galvanic aluminum material sufficient to generate heat, thereby reducing microbial growth, infectivity, and/or survival.

In specific examples, the nano-galvanic aluminum material comprises an anodic matrix.

In certain examples, the anodic matrix comprises aluminum, an aluminum alloy, or another aluminum-based composition.

In some examples, the nano-galvanic aluminum material comprises a cathodic phase comprising gallium, lead, manganese, silicon, magnesium, copper, bismuth, tin, or mixtures or alloys thereof.

In further examples, the cathodic phase is a dispersed phase.

In some examples, the cathodic phase comprises a plurality of particles having an average particle size that is on the nanoscale. In some examples, In some examples, the cathodic phase comprises a plurality of particles having an average particle size that is 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, 10 nm or less, or 5 nm or less). In some examples, the cathodic phase comprises a plurality of particles having an average particle size that is 50 nm or less.

In some examples, the cathodic phase comprises a plurality of particles having an average particle size of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, or 95 nm or more).

The average particle size of the plurality of particles of the cathodic phase can range from any of the minimum values described above to any of the maximum values described above. For example, the cathodic phase can comprise a plurality of particles having an average particle size from 1 to 100 nm (e.g., from 1 to 50 nm, from 50 to 100 nm, from 1 to 20 nm, from 20 to 40 nm, from 40 to 60 nm, from 60 to 80 nm, from 80 to 100 nm, from 1 to 80 nm, from 1 to 60 nm, from 1 to 40 nm, or from 1 to 10 nm). In some examples, the cathodic phase comprises a plurality of particles having an average particle size that is from 1 nm to 50 nm. In some examples, the cathodic phase comprises a plurality of particles having an average particle size that is from 5 nm to 50 nm.

In specific examples, the gallium, lead, manganese, silicon, magnesium, copper, bismuth, tin, or mixtures or alloys thereof are in a small particle.

In certain examples, the cathodic phase comprises tin. In some examples, the cathodic phase comprises more than 0% by weight of tin (Sn) (e.g., 1% or more, 2% or more, 3% or more, 4% or more, 5% or more, 6% or more, 7% or more, 8% or more, 9% or more, 10% or more, 11% or more, 12% or more, 13% or more, 14% or more, 15% or more, 16% or more, 17% or more, 18% or more, or 19% or more). In some examples, the cathodic phase comprises 20% by weight or less of tin (e.g., 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less). The amount of tin in the cathodic phase can range from any of the minimum values described above to any of the maximum values described above. In some examples, the cathodic phase comprises from more than 0 to 20% by weight of tin (e.g., from greater than 0 to 10%, from 10 to 20%, from greater than 0 to 5%, from 5 to 10%, from 10 to 15%, from 15 to 20%, from greater than 0 to 15%, from 1 to 20%, from 1 to 15%, from 1 to 10%, or from 2 to 8%). In some examples, the cathodic phase comprises from 2 to 8% by weight of tin.

In further examples, the cathodic phase comprises bismuth. In some examples, the cathodic phase comprises more than 0% by weight of bismuth (Bi) (e.g., 1% or more, 2% or more, 3% or more, 4% or more, 5% or more, 6% or more, 7% or more, 8% or more, 9% or more, 10% or more, 11% or more, 12% or more, 13% or more, 14% or more, 15% or more, 16% or more, 17% or more, 18% or more, or 19% or more). In some examples, the cathodic phase comprises 20% by weight or less of bismuth (e.g., 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less). The amount of bismuth in the cathodic phase can range from any of the minimum values described above to any of the maximum values described above. In some examples, the cathodic phase comprises from more than 0 to 20% by weight of bismuth (e.g., from greater than 0 to 10%, from 10 to 20%, from greater than 0 to 5%, from 5 to 10%, from 10 to 15%, from 15 to 20%, from greater than 0 to 15%, from 1 to 20%, from 1 to 15%, from 1 to 10%, or from 3 to 8%). In specific examples, the cathodic phase comprises from 3 to 8% by weight of bismuth.

In some examples, the cathodic phase comprises copper, silver, zinc, iron, or any combination thereof. In further examples, the cathodic phase comprises other antimicrobial metals.

In certain examples, the aluminum alloy in the anodic matrix comprises 1000 series aluminum, 2000 series aluminum, 3000 series aluminum, 4000 series aluminum, 5000 series aluminum, 6000 series aluminum, 7000 series aluminum, or any combination thereof.

In further examples, 1000 to 7000 series aluminum are wrought aluminum alloys. In certain examples, 1000 series aluminum, 3000 series aluminum, 4000 series aluminum, and 5000 series aluminum are non-heat-treatable alloys. In specific examples, 2000 series aluminum, 6000 series aluminum and 7000 series aluminum are heat-treatable alloys.

In some examples, 1000 series aluminum comprises pure aluminum.

In further examples, 2000 series aluminum comprises an aluminum (Al) and copper (Cu) alloy.

In certain examples, 3000 series aluminum comprises an Al and manganese (Mn) alloy.

In specific examples, 4000 series aluminum comprises an Al and silicon (Si) alloy.

In some examples, 5000 series aluminum comprises an Al and magnesium (Mg) alloy.

In further examples, 6000 series aluminum comprises an Al and Mg and Si alloy.

In certain examples, 7000 series aluminum comprises an Al and Mg and zinc (Zn) alloy.

In some examples, the cathodic phase comprises large particles of gallium, lead, manganese, silicon, magnesium, copper, bismuth, tin, or mixtures or alloys thereof, in addition to the small particles. In further examples, the large particles have an average characteristic dimension of from 100 nm to 1 mm.

In certain examples, the small particles reside within grains of the anodic matrix and the large particles reside between grains of the anodic matrix.

In specific examples, the cathodic phase also comprises stringers (elongated thin ribbons of Sn) having sizes from 10 nm to no more than 10 mm in size. In some examples, the galvanic metal microstructure comprises grains (individual crystalline areas) having a diameter of no more than 10 cm. In further examples, the galvanic metal microstructure is not annealed.

In certain examples, the cathodic phase consists essentially of tin or an alloy of tin.

In specific examples, the cathodic phase consists essentially of bismuth or an alloy of bismuth.

In some examples, the nano-galvanic aluminum material is made by melt spinning, spray atomization, inert gas condensation, solution precipitation, physical vapor deposition, or electrodeposition.

In further examples, wherein said nano-galvanic aluminum material contacts water, a water-containing liquid or another electrolyte, it produces at least 1100 mL of H₂ gas per gram of aluminum at 25° C. (298K) and 1 atmosphere within 5 minutes.

In certain examples, wherein said nano-galvanic aluminum material contacts water, a water-containing liquid or another electrolyte, it produces at least 1300 mL of H₂ gas per gram of aluminum at 25° C. (298K) and 1 atmosphere within 5 minutes.

In specific examples, the nano-galvanic aluminum material does not comprise any passivation agent or catalyst.

In some examples, the nano-galvanic aluminum material consists only of metals.

In further examples, the nano-galvanic aluminum material comprises an anodic matrix comprising aluminum, an aluminum alloy or another aluminum-based composition; and a cathodic phase, that is disperse, comprising small particles having an average characteristic dimension of from 2 nm to 100 nm of gallium, lead, manganese, silicon, magnesium, copper, bismuth, tin, or mixtures or alloys thereof at 7 % by weight; wherein the nano-galvanic aluminum material does not comprise any passivation agent or catalyst; wherein the cathodic phase forms galvanic couples with the anodic matrix to produce hydrogen gas when the nano-galvanic aluminum material contacts water, a water containing liquid, or another electrolyte, wherein the small particles of the cathodic phase reside within grains of the anodic matrix, and wherein when the nano-galvanic aluminum material contacts water, a water containing liquid, or another electrolyte, it produces at least 1000 mL of H₂ gas per gram of aluminum at 25° C. (298 K) and 1 atmosphere within 5 minutes.

In some examples, the microbe comprises a pathogen, wherein the pathogen is a virus, bacteria, fungi, protozoa, worm, or any combination thereof.

A pathogen is an organism causing disease to its host, with the severity of the disease symptoms referred to as virulence. Pathogens are taxonomically widely diverse and comprises viruses, bacteria, fungi, protozoa, and worms.

A virus is an infectious microbe comprising a segment of nucleic acid (either DNA or RNA) surrounded by a protein coat.

Bacteria are unicellular microorganisms with cell walls but lack organelles and an organized nucleus.

Fungi are spore-producing organisms feeding on organic matter.

Protozoa are single-celled microscopic animals, including amoebas, flagellates, ciliates, and sporozoans, for example.

Pathogenic worms are parasitic worms, also known as helminths, which can cause diseases in humans.

In further examples, the pathogen is the bacteria.

In some examples, bacteria include, but are not limited to, coliform, salmonella, shigella, and legionella, for example. In further examples, coliform includes Escherichia coli (E. coli).

In certain examples, the bacteria is coliform.

In specific examples, the coliform is Escherichia coli (E. coli). In certain examples, the microbe containing aqueous stream comprises wastewater. In some examples, the wastewater comprises domestic wastewater, industrial wastewater, commercial wastewater, agricultural wastewater, or any combination thereof.

Domestic wastewater includes used water from sources including, but not limited to, houses and apartments, coming from sources such as kitchen, bathroom, and laundry.

Industrial wastewater is by-product water that was used to make commercial products across every industry in any appropriate phase of production.

Commercial wastewater comes from non-domestic sources, such as beauty salons, auto body repair shops, and restaurants, for example.

Agricultural wastewater includes, but is not limited to, manure, milking center wash water, barnyard and feedlot runoff, egg washing and processing, slaughterhouse wastewater, horse washing water, and runoff associated with composting, for example.

In some examples, the microbe containing aqueous stream comprises water rich in pathogens, such as stagnant water.

In further examples, the small particle in the cathodic phase has an average characteristic dimension of 1 millimeter (mm) or less.

In specific examples, the small particle in the cathodic phase has an average characteristic dimension of 1000 nanometers (nm) or less.

In certain examples, the small particle in the cathodic phase has an average characteristic dimension of 500 nm or less.

In some examples, the small particle in the cathodic phase has an average characteristic dimension of 200 nm or less.

In further examples, the small particle in the cathodic phase has an average characteristic dimension of 100 nm or less.

In specific examples, the small particle in the cathodic phase has an average characteristic dimension of 50 nm or less.

Also provided herein is a method of reducing microorganism growth, infectivity, and/or survival comprising contacting a microorganism containing aqueous stream with a nano-galvanic aluminum material.

In some examples, the microorganism comprises multi-cell organisms, such as, but not limited to, insect larva, or other microorganisms in their aqueous stage life cycle.

In some examples, the method generates a by-product, wherein the by-product is a result of Al, Bi, and/or Sn reacting to form carbonates, oxides, and/or hydroxides which can in turn change the pH level. In some examples, the method generates a by-product, wherein the by-product is a result of Bi reacting to form carbonates, which can in turn change the pH level.

### Product

### Device

Provided herein is a wastewater treatment device comprising an enclosure, wherein the enclosure comprises a nano-galvanic aluminum material and a microbe containing aqueous stream, wherein the nano-galvanic aluminum material and the microbe containing aqueous stream are in contact with each other within the enclosure.

As used herein, enclosure refers to a container for holding fluid, including but not limited to, a conduit, reservoir, column, or a tank. In some examples, the enclosure has an inlet. In further examples, the enclosure has an outlet. In certain examples, the enclosure has an inlet and an outlet. In some examples, there is more than one inlet. In further examples, there is more than one outlet. In specific examples, the enclosure allows for a batch process. In some examples, the enclosure allows for a steady-state process. In further examples, the inlet and/or outlet have a valve for regulating fluid flow through the enclosure.

As used herein, conduit refers to a channel, tube, or trough, for example, for holding and/or conveying a fluid. In some examples, the conduit has two ends, wherein the two ends are open. In further examples, the two ends are closed. In certain examples, a first end is open, and a second end is closed.

As used herein, tank refers to a reservoir for holding fluid. In some examples, the tank is a cylinder. In further examples, the tank is rectangular. In some examples, the inlet is on the top or bottom surface of the tank. In further examples, the inlet is on the side of the tank. In certain examples, the outlet is on the top or bottom of the tank.

The enclosure can be made of materials including, but not limited to, metal, plastic, glass, or any combination thereof. In some examples, the enclosure comprises steel. In further examples, the tank comprises cross-linked polyethylene. In specific examples, the tank comprises linear polyethylene. In certain examples, the tank comprises fiberglass.

The enclosure allows for the nano-galvanic aluminum material to come into contact with the microbe containing aqueous stream. This can happen in varying ways including but not limited to, mixing or filtration, for example.

In some examples, the nano-galvanic aluminum material is combined with the microbe containing aqueous stream via mixing. In further examples, mixing is accomplished via a mixing utensil, a hand mixer, a mechanical mixer, a motorized mixer, wand mixer, or any combination thereof. In some examples, the mixing tool is fixed inside of the enclosure.

In further examples, the nano-galvanic aluminum material is combined with the microbe containing aqueous stream via filtration. In certain examples, filtration is accomplished via filtering the microbe containing aqueous stream in the enclosure through a filter that comprises the nano-galvanic aluminum material.

In some examples, the microbe containing aqueous stream contacts the nano-galvanic aluminum material via flowing through the powder in the enclosure. In further examples, the powder is packed sufficiently porous such that the fluid flows through the powder.

In some examples, the device is a standalone component for wastewater treatment, such that it is not integrated with other systems but rather is used on its own to treat wastewater with nano-galvanic aluminum material.

In further examples, the device is a component in a larger system for treating wastewater and is thereby integrated into the larger system.

### System

Provided herein is a wastewater treatment system comprising a nano-galvanic aluminum material and a microbe containing aqueous stream.

A number of embodiments of the disclosure have been described. Nevertheless, it will be understood that various modifications may be made without departing from the spirit and scope of the invention. Accordingly, other embodiments are within the scope of the following claims.

U.S. Pat. No. 11,198,923 is incorporated herein by reference.

By way of non-limiting illustration, examples of certain embodiments of the present disclosure are given below.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Microorganism Inactivation in Water Via Nano-Galvanic Aluminum Technology

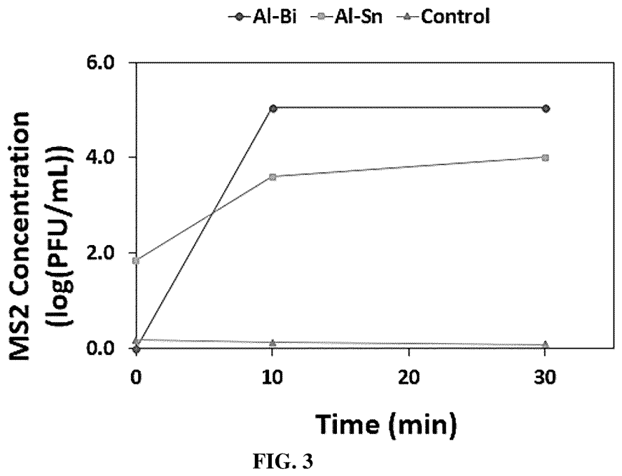

Aluminum powder is oxidized in water to form hydrogen gas. By alloying the aluminum with tin, bismuth or other metals, the reaction continued to completion, generating hydrogen gas, an alternative fuel. The reaction with water also produced heat and chemical conditions that are deadly to microorganisms, including pathogens. At sufficient concentrations, the nano-galvanic aluminum powder can inactivate or remove upwards of 99.99% (4-log₁₀) of MS2 virus within 10-30 minutes (FIG. 3). FIG. 3 is temperature-controlled (on ice) to prevent heat-based inactivation. This process can be used to kill harmful pathogens in water before the water is used for other purposes. The aluminum hydroxide left after the reaction was filtered out and recycled.

Water can harbor potentially dangerous pathogens, limiting its usability. Galvanic aluminum can react with water to produce heat and hydrogen. This reaction can inactivate bacteria, rendering the water safer for use.

Nano-galvanic aluminum is an aluminum alloy powder with nano-scale topography. Alloying with bismuth or tin creates a galvanic cell. This allows for a vigorous reaction at room temperatures.

Pathogens can be inactivated and/or removed from water via many mechanisms. Heat alone can inactivate bacteria and viruses with time. The inactivation and/or removal process also occurs in temperature-controlled experiments (e.g., FIG. 3).

Bismuth has the capability to combat pathogenic bacteria and effectively treat infections and inflammatory diseases.

The hydrogen produced by the reaction can be captured for use. Based on the starting water quality, the resulting water can have varying applications. Both fuel and water treatment are valuable applications in inaccessible areas.

### Exemplary Aspects

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A method of reducing microbial growth, infectivity, and/or survival, the method comprising contacting a microbe containing aqueous stream with a nano-galvanic aluminum material.

Example 2: The method of any example herein, particularly example 1, wherein the nano-galvanic aluminum material is a powder.

Example 3: The method of any example herein, particularly example 1, wherein the nano-galvanic aluminum material is a green compact, fully dense piece, or 3D printed lattice-type structure.

Example 4: The method of any example herein, particularly examples 1-3, wherein the microbe containing aqueous stream is contacted with an amount of the nano-galvanic aluminum material sufficient to generate heat, thereby reducing microbial growth, infectivity, and/or survival.

Example 5: The method of any example herein, particularly examples 1-4, wherein the nano-galvanic aluminum material comprises an anodic matrix.

Example 6: The method of any example herein, particularly example 5, wherein the anodic matrix comprises aluminum, an aluminum alloy, or another aluminum-based composition.

Example 7: The method of any example herein, particularly examples 1-6, wherein the nano-galvanic aluminum material comprises a cathodic phase comprising gallium, lead, manganese, silicon, magnesium, copper, bismuth, tin, or mixtures or alloys thereof.

Example 8: The method of any example herein, particularly example 7, wherein the cathodic phase is a disperse phase.

Example 9: The method of any example herein, particularly examples 7-8, wherein the gallium, lead, manganese, silicon, magnesium, copper, bismuth, tin, or mixtures or alloys thereof are in a small particle.

Example 10: The method of any example herein, particularly examples 7-9, wherein the cathodic phase comprises tin.

Example 11: The method of any example herein, particularly example 10, wherein the cathodic phase comprises from more than 0 to 20% by weight of tin.

Example 12: The method of any example herein, particularly example 11, wherein the cathodic phase comprises from 2 to 8% by weight of tin.

Example 13: The method of any example herein, particularly examples 6-12, wherein the cathodic phase comprises bismuth.

Example 14: The method of any example herein, particularly example 13, wherein the cathodic phase comprises from more than 0 to 20% by weight of bismuth.

Example 15: The method of any example herein, particularly example 14, wherein the cathodic phase comprises from 3 to 8% by weight of bismuth.

Example 16: The method of any example herein, particularly examples 7-15, wherein the cathodic phase comprises copper, silver, zinc, iron, or any combination thereof.

Example 17: The method of any example herein, particularly examples 6-16, wherein the aluminum alloy in the anodic matrix comprises 1000 series aluminum, 2000 series aluminum, 3000 series aluminum, 4000 series aluminum, 5000 series aluminum, 6000 series aluminum, 7000 series aluminum, or any combination thereof.

Example 18: The method of any example herein, particularly examples 1-17, wherein the microbe comprises a pathogen, wherein the pathogen is a virus, bacteria, fungi, protozoa, worm, or any combination thereof.

Example 19: The method of any example herein, particularly example 18, wherein the pathogen is the bacteria.

Example 20: The method of any example herein, particularly examples 18-19, wherein the bacteria is coliform.

Example 21: The method of any example herein, particularly example 20, wherein the coliform is Escherichia coli (E. coli).

Example 22: The method of any example herein, particularly examples 1-21, wherein the microbe containing aqueous stream comprises wastewater.

Example 23: The method of any example herein, particularly example 22, wherein the wastewater comprises domestic wastewater, industrial wastewater, commercial wastewater, agricultural wastewater, or any combination thereof.

Example 24: The method of any example herein, particularly examples 9-23, wherein the small particle in the cathodic phase has an average characteristic dimension of 1 millimeter (mm) or less.

Example 25: The method of any example herein, particularly examples 9-23, wherein the small particle in the cathodic phase has an average characteristic dimension of 1000 nanometers (nm) or less.

Example 26: The method of any example herein, particularly examples 9-23, wherein the small particle in the cathodic phase has an average characteristic dimension of 500 nm or less.

Example 27: The method of any example herein, particularly examples 9-23, wherein the small particle in the cathodic phase has an average characteristic dimension of 200 nm or less.

Example 28: The method of any example herein, particularly examples 9-23, wherein the small particle in the cathodic phase has an average characteristic dimension of 100 nm or less.

Example 29: The method of any example herein, particularly examples 9-23, wherein the small particle in the cathodic phase has an average characteristic dimension of 50 nm or less.

Example 30: A wastewater treatment device comprising an enclosure, wherein the enclosure comprises a nano-galvanic aluminum material and a microbe containing aqueous stream, wherein the nano-galvanic aluminum material and the microbe containing aqueous stream are in contact with each other within the enclosure.

Example 31: A water treatment system comprising a nano-galvanic aluminum material and a microbe containing aqueous stream.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A method of reducing microbial growth, infectivity, and/or survival, the method comprising contacting a microbe containing aqueous stream with a nano-galvanic aluminum material.

2. The method of claim 1, wherein the nano-galvanic aluminum material is a powder.

3. The method of claim 1, wherein the nano-galvanic aluminum material is a green compact, fully dense piece, or 3D printed lattice-type structure.

4. The method of claim 1, wherein the microbe containing aqueous stream is contacted with an amount of the nano-galvanic aluminum material sufficient to generate heat, thereby reducing microbial growth, infectivity, and/or survival.

5. The method of claim 1, wherein the nano-galvanic aluminum material comprises an anodic matrix.

6. The method of claim 5, wherein the anodic matrix comprises aluminum, an aluminum alloy, or another aluminum-based composition.

7. The method of claim 1, wherein the nano-galvanic aluminum material comprises a cathodic phase comprising gallium, lead, manganese, silicon, magnesium, copper, bismuth, tin, or mixtures or alloys thereof.

8. The method of claim 7, wherein the cathodic phase is a disperse phase.

9. The method of claim 7, wherein the gallium, lead, manganese, silicon, magnesium, copper, bismuth, tin, or mixtures or alloys thereof are in a small particle.

10. The method of claim 7, wherein the cathodic phase comprises tin.

11. The method of claim 10, wherein the cathodic phase comprises from more than 0 to 20% by weight of tin.

12. The method of claim 7, wherein the cathodic phase comprises bismuth.

13. The method of claim 12, wherein the cathodic phase comprises from more than 0 to 20% by weight of bismuth.

14. The method of claim 7, wherein the cathodic phase comprises copper, silver, zinc, iron, or any combination thereof.

15. The method of claim 6, wherein the aluminum alloy in the anodic matrix comprises 1000 series aluminum, 2000 series aluminum, 3000 series aluminum, 4000 series aluminum, 5000 series aluminum, 6000 series aluminum, 7000 series aluminum, or any combination thereof.

16. The method of claim 1, wherein the microbe comprises a pathogen, wherein the pathogen is a virus, bacteria, fungi, protozoa, worm, or any combination thereof.

17. The method of claim 1, wherein the microbe containing aqueous stream comprises wastewater.

18. The method of claim 17, wherein the wastewater comprises domestic wastewater, industrial wastewater, commercial wastewater, agricultural wastewater, or any combination thereof.

19. A wastewater treatment device comprising an enclosure, wherein the enclosure comprises a nano-galvanic aluminum material and a microbe containing aqueous stream, wherein the nano-galvanic aluminum material and the microbe containing aqueous stream are in contact with each other within the enclosure.

20. A water treatment system comprising a nano-galvanic aluminum material and a microbe containing aqueous stream.
